(19) United States
(12) Patent Application Publication
(10) Pub. No.: US 2023/0409833 A1
(43) Pub. Date: Dec. 21, 2023

(54) INFORMATION PROCESSING SYSTEM AND INFORMATION PROCESSING METHOD

(71) Applicant: VALUENEX Japan, Inc., TOKYO (JP)

(72) Inventors: Tatsuo NAKAMURA, TOKYO (JP); Hirotaka KATAGIRI, TOKYO (JP); Tao WANG, TOKYO (JP); Akira ARAI, TOKYO (JP)

(21) Appl. No.: 18/206,222

(22) Filed: Jun. 6, 2023

(30) Foreign Application Priority Data
Jun. 21, 2022 (JP) 2022-099924

(51) Int. Cl. G06F 40/284; G06F 40/242

(52) U.S. Cl. CPC G06F 40/284; G06F 40/242

(57) ABSTRACT

The present invention provides an information processing system that can process processing target information while confidentiality of the processing target information is retained. An information processing system 1 includes a first encrypted information generation unit 110 that is provided to the first information terminal 11 and that generates first encrypted information as information resulting from encryption of each of plural pieces of processing target information, a second encrypted information generation unit 120 that is provided to the second information terminal 12 and that generates second encrypted information as information processed without decrypting plural pieces of first encrypted information, and a decryption processing unit 111 that is provided to the first information terminal 11, decrypts the second encrypted information, and acquires the processing result information.

### BACKGROUND OF THE INVENTION

### Field of the Invention

The present invention relates to an information processing system and so forth in which various processes such as an analysis are practiced on processing target information, which is encrypted and is transmitted from one information terminal, in another information terminal.

### Description of the Related Art

In recent years, accompanying development of information and communications technology, services have been spread which practice predetermined processes such as management or analyses of information owned by individuals, companies and the like. In this case, an individual or a company has to transmit information from an information terminal owned by the individual or the company to an information terminal of a service provider. In the above transmission of information, in order to secure security, encryption or the like of information is usually performed.

Japanese Patent Laid-Open No. 2020-086116 discloses a system that includes an information processing server which receives information which is encrypted and transmitted from an information processing terminal on a user side (individual or company side), analyzes the encrypted information, generates an encryption index as an analysis result in an encrypted state, and returns the encryption index to the information processing terminal. The system is capable of practicing a predetermined process for data of confidential information without disclosing the confidential information to a service manager (service provider) as a manager of a server, or the like.

However, according to a system disclosed in Japanese Patent Laid-Open No. 2020-086116, in order to practice an analysis of analysis target information (processing target information), a pre-analytical process such as categorization of words by a dictionary is performed on a server side (service provider side). At this point, because a part of information is decrypted, confidentiality of the analysis target information is not completely ensured. That is, there is a problem that the analysis target information cannot be analyzed while confidentiality of the analysis target information is retained.

The present invention has been made in consideration of the above problem, and an object thereof is to provide an information processing system and an information processing method that can practice a predetermined process including an analysis on processing target information while confidentiality of the processing target information is retained.

### SUMMARY OF THE INVENTION

An information processing system of the present invention is

an information processing system including:

a first information terminal; and

a second information terminal being independent from the first information terminal and being capable of communicating with the first information terminal,

the second information terminal practicing a predetermined process on plural pieces of processing target information transmitted from the first information terminal,

the first information terminal acquiring processing result information being a result of the predetermined process, in which

the information processing system includes:

a first encrypted information generation unit that is provided to the first information terminal and that generates first encrypted information as information resulting from encryption of each of the plural pieces of processing target information;

a second encrypted information generation unit that is provided to the second information terminal and that generates second encrypted information as information which results from practicing the predetermined process on plural pieces of the first encrypted information without decrypting the plural pieces of the first encrypted information; and

a decryption processing unit that is provided to the first information terminal, decrypts the second encrypted information, and acquires the processing result information.

According to the information processing system in such a configuration, the processing target information is encrypted by the first information terminal and is transmitted to the second information terminal. Then, the second information terminal practices the predetermined process on the encrypted information without decrypting the encrypted information and generates the second encrypted information as a processing result of that. Subsequently, the processing result can be known only after the second encrypted information is decrypted by the first information terminal.

Thus, in a process in the second information terminal, the processing target information itself and specific contents of the processing result cannot be known even if those were referred to at any timing in steps of the process. Consequently, according to the information processing system, the processing target information can be processed while confidentiality of the processing target information is retained.

In this case, in the information processing system of the present invention,

the predetermined process preferably includes at least one of an analysis, an examination, statistics, and totalization.

Further, in the information processing system of the present invention,

the first encrypted information generation unit preferably includes

a word extraction unit which extracts plural words included in each of the plural pieces of processing target information,

a frequency information generation unit which generates, for each of the plural pieces of processing target information, based on the number of appearances of each of the plural words, frequency information as information about an appearance frequency of the word in the processing target information,

a correspondence information generation unit which generates, for each of the plural words which are extracted, correspondence information as information representing a correspondence relationship between the word and a character string corresponding to the word, and

a first encryption processing unit which encrypts the frequency information to form the first encrypted information by converting plural words included in the frequency information based on the correspondence information, and

the decryption processing unit preferably acquires the processing result information by decrypting the second encrypted information based on the correspondence information.

According to the information processing system in such a configuration, the first encrypted information generation unit (further, the first information terminal) generates the frequency information based on the numbers of appearances of plural words included in the processing target information and sets information resulting from encryption of the frequency information as the first encrypted information.

That is, the first encrypted information has a small data amount compared to information in which all texts of the processing target information are encrypted. Accordingly, a load in transmission to the second information terminal and in processing in the second information terminal can be made small.

Further, such information resulting from encryption of the frequency information exhibits high confidentiality compared to information resulting from encryption of only the processing target information itself. Accordingly, confidentiality of the processing target information can be retained at a high level.

Further, in the information processing system of the present invention,

when the processing target information included in the plural pieces of processing target information is changed, the correspondence information generation unit preferably generates new correspondence information by using a character string which is different from a character string used in the correspondence information which is not yet changed.

According to the information processing system in such a configuration, at each time when a population of the processing target information is changed, the correspondence information is also changed, and a method of encrypting the frequency information is also changed. Consequently, the information processing system can retain confidentiality of the processing target information at a high level.

Further, in the information processing system of the present invention,

the correspondence information generation unit preferably generates the correspondence information by using a character string formed with alphabets.

A character string formed with alphabets has a small data amount compared to Chinese characters or the like. Accordingly, when the correspondence information is generated with a character string formed with alphabets as described above, the data amount of the frequency information encrypted by the correspondence information can be made small. Accordingly, a load in transmission to the second information terminal and in processing in the second information terminal can be made small.

Further, in the information processing system of the present invention,

the first encrypted information generation unit preferably includes a dictionary data storage unit that stores dictionary data as data which indicate correlations among the plural words, and

the word extraction unit preferably extracts a word included in each of the plural pieces of processing target information by using the dictionary data.

According to the information processing system in such a configuration, the dictionary data serving as a base of encryption processes are provided to the first information terminal including the first encrypted information generation unit. The dictionary data can easily be updated by a user of the first information terminal. Thus, by referring to the dictionary data, word information can appropriately be extracted from the processing target information, and further a more specific process can be performed.

Further, in the information processing system of the present invention,

each of the plural pieces of processing target information preferably includes attribute information as information representing a different attribute for each piece of the processing target information,

the first encrypted information generation unit preferably includes an ID attachment unit which attaches an ID to each of the plural pieces of processing target information and a communication unit which associates the ID corresponding to the first encrypted information with each of plural pieces of the first encrypted information and transmits the ID and the first encrypted information to the second information terminal,

the second encrypted information generation unit preferably processes plural pieces of the first encrypted information associated with the IDs and generates the second encrypted information, and

the decryption processing unit preferably decrypts the second encrypted information, acquires the processing result information, and attaches the attribute information to the processing result information based on the ID.

The processing target information includes information which is not necessary for a process itself but is useful for reference subsequent to the process. Accordingly, as described above, when a configuration is made such that information included in the processing target information is separated into the ID indicating the processing target information and the attribute information and the associated ID is not changed before or after the process, the process can be performed only with necessary information (that is, information except the attribute information) for the process in the processing target information, and the attribute information can be attached by subsequently referring to the ID.

Accordingly, by the amount of removed attribute information, confidentiality of the processing target information can be retained at a high level. Further, a load in transmission to the second information terminal and in processing in the second information terminal can be made small.

Further, an information processing method of the present invention is

an information processing method in which a second information terminal practices a predetermined process on plural pieces of processing target information transmitted from a first information terminal and the first information terminal acquires processing result information being a result of the predetermined process, the information processing method including:

a step of generating first encrypted information as information resulting from encryption of each of the plural pieces of processing target information in the first information terminal;

a step of generating, in the second information terminal, second encrypted information as information which results from practicing the predetermined process on plural pieces of the first encrypted information without decrypting the plural pieces of the first encrypted information; and

a step of decrypting the second encrypted information and of acquiring the processing result information in the first information terminal.

### BRIEF DESCRIPTION OF THE DRAWINGS

FIG. 1 is a schematic diagram illustrating a configuration of an information processing system of the present invention;

FIG. 2 is a block diagram illustrating a functional configuration of a first information terminal of the information processing system of the present invention;

FIG. 3 is a block diagram illustrating a functional configuration of a second information terminal of the information processing system of the present invention;

FIG. 4 is a sequence diagram illustrating a series of control processes of encryption and an information analysis which are performed by the information processing system of the present invention;

FIG. 5 is a flowchart illustrating a control process which is performed by the first information terminal and generates first encrypted information in the information processing system of the present invention;

FIG. 6 is a diagram illustrating one example of text information;

FIG. 7 is a diagram illustrating one example of frequency information;

FIG. 8 is a diagram illustrating one example of correspondence information;

FIG. 9 is a diagram illustrating one example of first encrypted information;

FIG. 10 is a diagram illustrating one example of second encrypted information; and

FIG. 11 is a diagram illustrating one example of an analysis result.

### DETAILED DESCRIPTION OF THE PREFERRED EMBODIMENT

### (Configuration of Information Processing System 1)

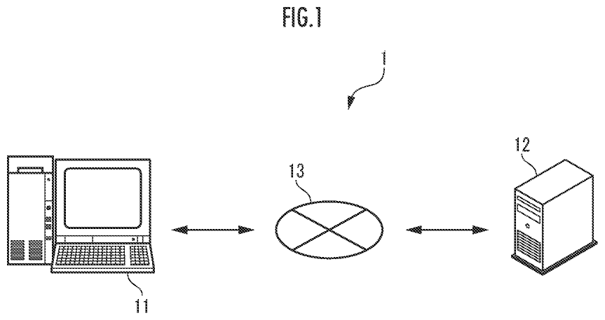

An information processing system 1 according to one embodiment of the present invention will be described by the following descriptions and drawings. Note that the following descriptions are descriptions about an example where a predetermined process of the present embodiment is an analysis process of information. As illustrated in FIG. 1, the information processing system 1 of the present embodiment includes a first information terminal 11 and a second information terminal 12. The first information terminal 11 and the second information terminal 12 are independent from each other.

Further, the first information terminal 11 and the second information terminal 12 are connected with each other via a network 13 to be capable of communication. In this case, the network 13 is configured with the Internet, a LAN, and so forth. Further, the first information terminal 11 is a personal computer (PC), and the second information terminal 12 is a server. Note that the first information terminal 11 may be an information terminal other than a PC, such as a smartphone, a tablet, and a server, and the second information terminal 12 may be an information terminal other than a server, such as a PC, a smartphone, and a tablet.

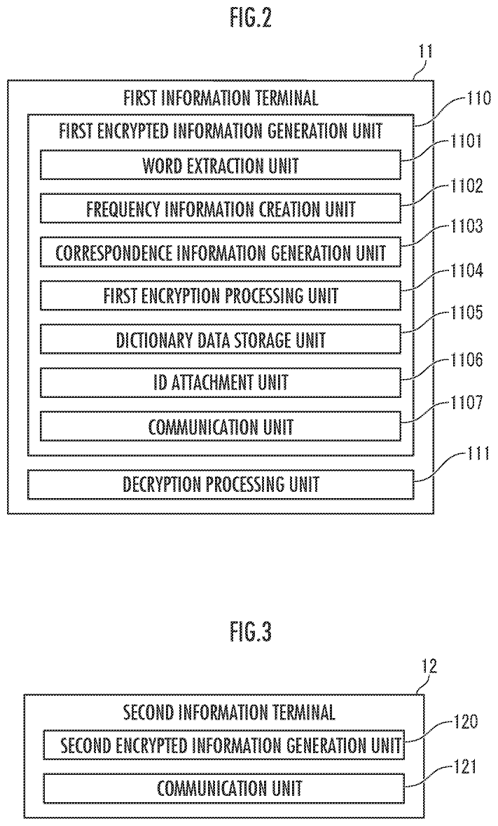

The first information terminal 11 is configured with a CPU, a memory, an I/O interface, and a storage device such as a ROM, a RAM, or an HDD, and so forth and practices various control processes such as an encryption process, a decryption process, and a pre-analytical process, which will be described later. As illustrated in FIG. 2, the first information terminal 11 includes a first encrypted information generation unit 110 and a decryption processing unit 111.

The first encrypted information generation unit 110 is configured with a word extraction unit 1101, a frequency information creation unit 1102, a correspondence information generation unit 1103, a first encryption processing unit 1104, a dictionary data storage unit 1105, an ID attachment unit 1106, a communication unit 1107, and so forth.

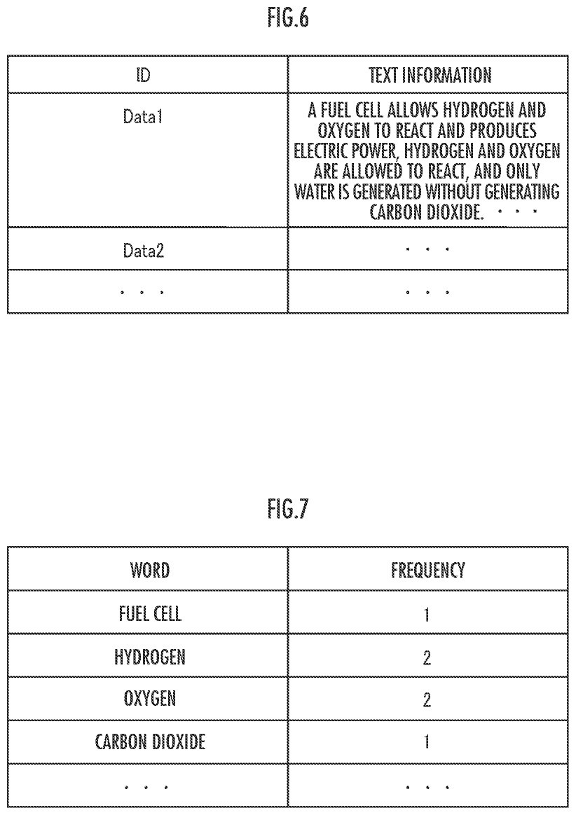

As described later, the first encrypted information generation unit 110 practices an encryption process and an analysis process in order to set analysis target information (processing target information) possessed by a possessor of the first information terminal 11, as described later and illustrated in FIG. 6, to a state suitable for an analysis by the second information terminal 12.

As described later, the word extraction unit 1101 extracts a word from designated analysis target information. Specifically, the word extraction unit 1101 uses word dictionary data and a word extraction program which are incorporated in the dictionary data storage unit 1105, thereby divides words from a text, and extracts words to be used for a text analysis.

As described later, the frequency information creation unit 1102 totalizes an appearance frequency of each of the words resulting from the division by the word extraction unit 1101 and generates frequency information as information about appearance frequencies of words.

As described later, as for each of the words resulting from the division by the word extraction unit 1101, the correspondence information generation unit 1103 generates correspondence information as information representing a correspondence relationship between each of the words and a predetermined character string corresponding to the word.

As described later, the first encryption processing unit 1104 converts each of plural words included in the frequency information generated by the frequency information creation unit 1102 based on the correspondence information generated by the correspondence information generation unit 1103 and thereby generates first encrypted information.

As described later, the dictionary data storage unit 1105 is a database which is for the word extraction unit 1101 to perform a process and stores a word dictionary (not illustrated) which is used for word extraction and includes word information.

As described later, the ID attachment unit 1106 attaches an ID (see FIG. 6) to each piece of the analysis target information and attaches, based on the ID, attribute information as information representing a document as a word extraction source, a document creator, a creation date, and so forth of each piece of the analysis target information.

The communication unit 1107 is configured with a communication device and so forth and transmits the first encrypted information, which is generated by the first information terminal 11, to the second information terminal 12 via the network 13. Further, the communication unit 1107 receives second encrypted information which is generated by the second information terminal 12 described later.

The decryption processing unit 111 decrypts the second encrypted information generated by the second information terminal 12 described later and acquires analysis result information.

Next, the second information terminal 12 will be described. As illustrated in FIG. 3, the second information terminal 12 is configured with a CPU, a memory, an I/O interface, a storage device such as a ROM, a RAM, or an HDD, and so forth and practices control processes such as an analysis process described later. Further, the second information terminal 12 includes a second encrypted information generation unit 120 and a communication unit 121.

As described later, the second encrypted information generation unit 120 analyzes plural pieces of the first encrypted information and generates the second encrypted information as analysis result information.

The communication unit 121 is configured with a communication device and so forth and receives the first encrypted information, which is generated by the first information terminal 11, via the network 13. Further, the communication unit 121 transmits the second encrypted information, which is generated by the second information terminal 12, to the first information terminal 11.

### (Information Processing Method of Information Processing System 1)

The following description is a detailed description of various processes and functions of the information processing system 1 of the present embodiment. As described above, the information processing system 1 and an information processing method according to the present embodiment practice an analysis process on processing target information while confidentiality of the analysis target information is retained.

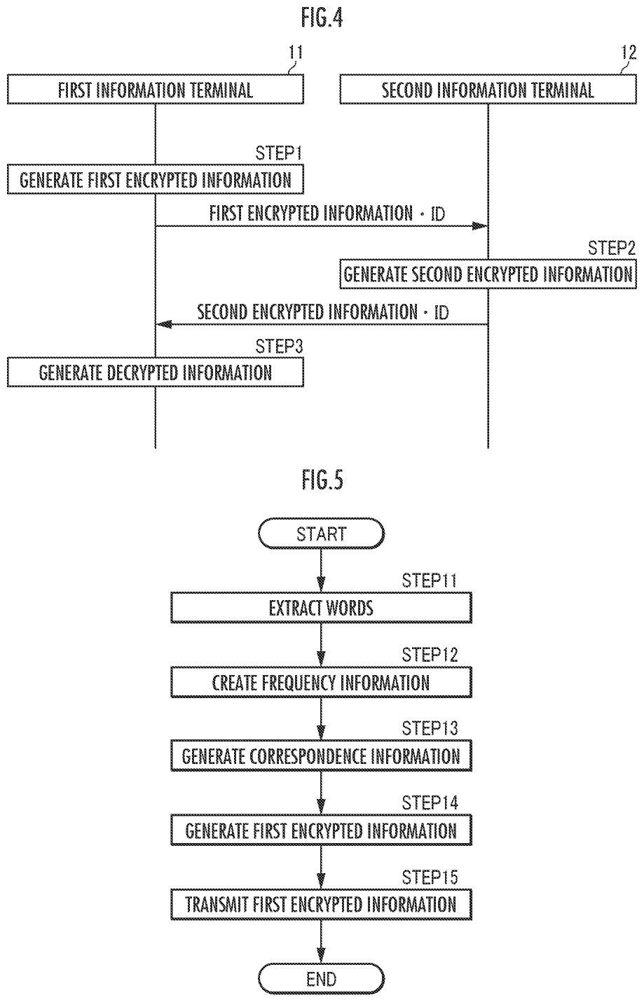

The following description is a description about a series of control processes of encryption and an information analysis which are performed by the information processing system 1, and FIG. 4 will be referred to. As illustrated in FIG. 4, first, the first information terminal 11 generates the first encrypted information (STEP 1 in FIG. 4). Specifically, this process is practiced as illustrated in FIG. 5.

As illustrated in FIG. 5, first, words are extracted from the analysis target information which is designated by a possessor of the first information terminal 11 (STEP 11 in FIG. 5).

Here, as illustrated in FIG. 6, the analysis target information is plural pieces of text information which are configured with plural words. In this case, the word information is acquired from the text information by using a predetermined analysis algorithm based on predetermined dictionary data. Here, the dictionary data are data which indicate correlations among plural words.

In the present embodiment, an example will be disclosed where the analysis target information is text information in English; however, the analysis target information of the present invention is not limited to text information in English. For example, text information may be in a predetermined foreign language such as Japanese, Chinese, or French other than English or may be text information including plural languages (for example, text information formed with English and Japanese). Further, for example, as other analysis target information than text information, image information, questionnaire information (totalization information), purchase information, customer information, and so forth may be used.

Further, the dictionary data are stored in the first information terminal 11. As the dictionary data, it is preferable to use dictionary data which are standardly used by Natural Language Tool Kit (NLTK) of Python, spaCy, and so forth. Alternatively, the possessor of the first information terminal 11 prepares arbitrary dictionary data, and precision of word extraction can thereby be enhanced. Further, by setting stop words and so forth in the dictionary data, words with particularly high confidentiality or the like can be prevented from being extracted. Further, the dictionary data can be configured to be capable of being updated. Accordingly, because information of newest words or the like is reflected in the dictionary data, precision of word extraction is enhanced. Further, in transmission to the second information terminal 12, which will be described later, unnecessary words and stop words do not have to be transmitted, and not all of duplicate words have to be transmitted. Consequently, a data amount is decreased compared to in transmission of whole text information, and it becomes possible to increase speeds of an analysis and communication.

Further, as an extraction method (extraction program) of words, it is preferable to use a morphological analysis. In a case where the text information is in English, in the morphological analysis, it is preferable to use a morphological analysis function provided to NLTK, spaCy, or the like as an existing natural language processing program, but the morphological analysis is not limited to this. The present invention can also be practiced for other languages than English, and a suitable morphological analysis may be used for each language. For example, in a case where the text information is in Japanese, in the morphological analysis, MeCab, ChaSen, Janome, or Sudachi as existing morphological analysis software can be used. Further, a method of word extraction is not limited to a morphological analysis, but an arbitrary analysis procedure for a person having ordinary skill in the art such as rule-based natural language processing may be used.

When words are extracted as described above, the frequency information is next generated for each of the extracted words (STEP 12 in FIG. 5). As illustrated in FIG. 7, the frequency information is information representing the appearance frequency of each word included in the text information. In FIG. 7, only ID-Data1 in FIG. 6 are indicated as the frequency information, but the frequency information is similarly created for plural pieces of text information to which respective IDs are attached. The following description is a description in which only ID-Data1 serve as a target, but the same applies to other IDs.

Further, for the frequency information, not only information representing appearances of words in each text but also uneven distribution information as an uneven distribution degree of each word in each text may be generated at the same time. Here, the uneven distribution degree is a numerical value which results from quantification based on whether an arbitrary word is a word which is widely used in plural literatures or a word which is used only in a specific literature. In this case, the uneven distribution degree may be quantified based not on plural literatures but on each of plural paragraphs or IDs.

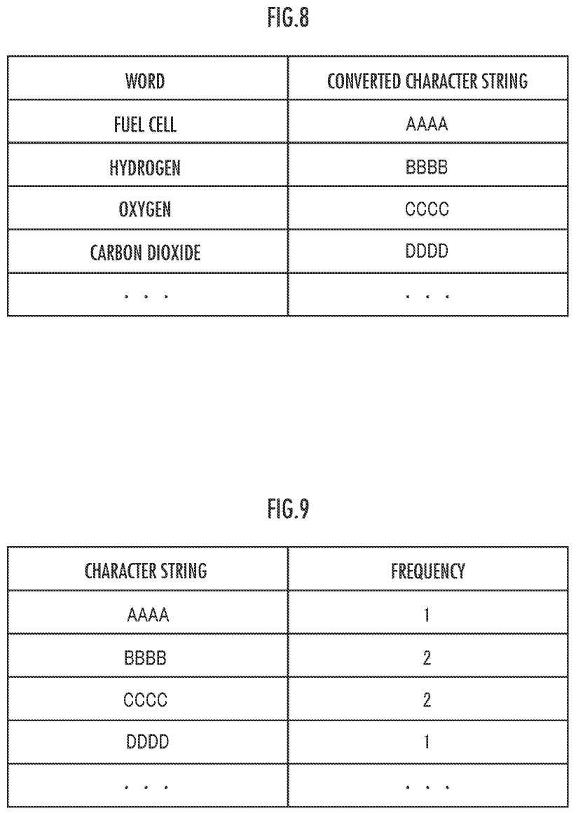

Next, as for each of the plural extracted words, the correspondence information is generated which is information representing the correspondence relationship between the word and a character string corresponding to the word (STEP 13 in FIG. 5). In this case, as illustrated in FIG. 8, the correspondence information generation unit 1103 generates the correspondence information by using a character string formed with alphabets. However, a generation procedure of the correspondence information is not limited to this. A character string including at least one kind of character of numeral, sign, and alphabet other than alphabets may be generated as the correspondence information.

Although a generation method of a character string is not particularly limited, in view of securing confidentiality, when the analysis target information included in plural pieces of analysis target information is changed, it is preferable to use, as the correspondence information resulting from the change, a character string which is different from a character string used in the correspondence information at a time when the change has not yet been made. That is, it is preferable to attach a different character string to even the same word in a case of text information to which a different ID is attached or of different analysis target information. Further, in view of confidentiality, a character string is preferably generated at random based on random numbers but may be generated by an arbitrary procedure for a person having ordinary skill in the art.

Next, plural words included in the frequency information are converted based on the correspondence information, the frequency information is thereby encrypted, and the first encrypted information is generated (STEP 14 in FIG. 5). As illustrated in FIG. 9, the first encrypted information is information indicating character strings and frequencies which are encrypted.

After the first encrypted information as the encrypted frequency information is generated, the first encrypted information together with the ID is transmitted from the first information terminal 11 to the second information terminal 12 via the network 13 by an operation or the like by the possessor of the first information terminal 11 (STEP 15 in FIG. 5). The ID, which is associated with the attribute information as information representing a different attribute for each piece of analysis target information, is attached to the text information, and is transmitted at the same time. In the present embodiment, an example is described where the ID is transmitted together with the first encrypted information, but generation and transmission of the ID may be omitted.

In this case, the first encrypted information and so forth may be transmitted by an operation by the possessor, and further the first encrypted information may be transmitted to the second information terminal 12 by predetermined control at the same time as generation.

Returning to FIG. 4, in a case where the second information terminal 12 receives both of the first encrypted information and the ID, the second information terminal 12 generates the second encrypted information based on the first encrypted information (STEP 2 in FIG. 4). In this case, the second information terminal 12 analyzes the first encrypted information by a predetermined analysis procedure and thereby generates the second encrypted information.

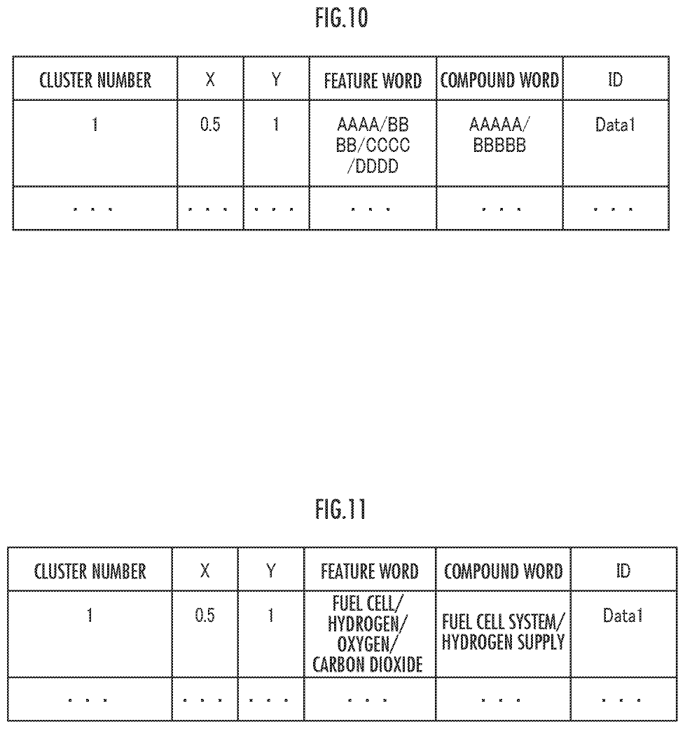

Specifically, as illustrated in FIG. 10, the second encrypted information is coordinate information (coordinate information in a birds-eye view) which can be obtained by analyzing a feature amount (coordinates of each text) of each encrypted character string based on the encrypted frequency information as first encrypted information. Note that the second encrypted information is not limited to coordinate information but may be a birds-eye view itself. Further, the second encrypted information is not limited to those examples but may be information which is analyzed by the second information terminal 12 by totalizing the frequencies of words in a document.

Further, in the above analysis, in a case where plural pieces of first encrypted information are received, similarity among groups of the plural pieces of first encrypted information may be analyzed. Although analysis procedures of the feature amount and similarity are not particularly limited, as analysis procedures of the feature amount, methods based on a tf-idf method, Okapi BM25, Bag of Words, and so forth may be used. Further, as in latent dirichlet allocation (LDA) or the like, dimensions of an initial feature amount are decreased by using singular value decomposition or a principal component analysis, and the feature amount may thereby be analyzed based on the decreased dimensions. As analysis procedures of similarity, cosine similarity, the Euclidean distance, and so forth may be used based on the feature amount obtained by the above-described methods. Further, in a case where plural texts are analyzed, similarity may not be in a matrix form but an XY coordinates as a projection of two-dimensional coordinates (see FIG. 10). In addition, a compound word formed with plural characters may be generated at the same time (see FIG. 10). By generating the compound word, the possessor of the first information terminal 11 can more easily know information of a text.

When the second encrypted information is generated in the second information terminal 12, as illustrated in FIG. 4, the second encrypted information and the ID are transmitted to the first information terminal 11 by an operation by a possessor of the second information terminal 12 or by control of the second information terminal 12.

In a case where the first information terminal 11 receives both of the second encrypted information and the ID, the first information terminal 11 decrypts the second encrypted information and acquires the analysis target information (STEP 3 in FIG. 4). In this case, the second encrypted information is decrypted by an encryption key (above-described correspondence information) which is generated in a phase of generating the first encrypted information. Accordingly, the possessor of the first information terminal 11 can acquire an analysis result as illustrated in FIG. 11. Consequently, information is not leaked to the possessor of the second information terminal 12 and a person committing illegal interception in the network 13, and only the possessor of the first information terminal 11 can acquire the analysis target information.

Further, in this case, based on the ID attached to the analysis result, it becomes possible to easily check the attribute information (such as an original document, a creator of a document, and a creation date) associated with the analysis result.

### REFERENCE SIGNS LIST

1 information processing system
11 first information terminal
12 second information terminal
13 network
110 first encrypted information generation unit
111 decryption processing unit
120 second encrypted information generation unit
121 communication unit (second information terminal)
1101 word extraction unit
1102 frequency information creation unit
1103 correspondence information generation unit
1104 first encryption processing unit
1105 dictionary data storage unit
1106 ID attachment unit
1107 communication unit (first information terminal)

What is claimed is:

1. An information processing system comprising:
a first information terminal; and
a second information terminal being independent from the first information terminal and being capable of communicating with the first information terminal,
the second information terminal practicing a predetermined process on plural pieces of processing target information transmitted from the first information terminal,
the first information terminal acquiring processing result information being a result of the predetermined process, wherein
the information processing system comprises:
a first encrypted information generation unit that is provided to the first information terminal and that generates first encrypted information as information resulting from encryption of each of the plural pieces of processing target information;
a second encrypted information generation unit that is provided to the second information terminal and that generates second encrypted information as information which results from practicing the predetermined process on plural pieces of the first encrypted information without decrypting the plural pieces of the first encrypted information; and
a decryption processing unit that is provided to the first information terminal, decrypts the second encrypted information, and acquires the processing result information.

2. The information processing system according to claim 1, wherein
the predetermined process includes at least one of an analysis, an examination, statistics, and totalization.

3. The information processing system according to claim 1, wherein
the first encrypted information generation unit includes
a word extraction unit which extracts plural words included in each of the plural pieces of processing target information,
a frequency information generation unit which generates, for each of the plural pieces of processing target information, based on the number of appearances of each of the plural words, frequency information as information about an appearance frequency of the word in the processing target information,
a correspondence information generation unit which generates, for each of the plural words which are extracted, correspondence information as information representing a correspondence relationship between the word and a character string corresponding to the word, and
a first encryption processing unit which encrypts the frequency information to form the first encrypted information by converting plural words included in the frequency information based on the correspondence information, and
the decryption processing unit acquires the processing result information by decrypting the second encrypted information based on the correspondence information.

4. The information processing system according to claim 3, wherein
when the processing target information included in the plural pieces of processing target information is changed, the correspondence information generation unit generates new correspondence information by using a character string which is different from a character string used in the correspondence information which is not yet changed.

5. The information processing system according to claim 3, wherein
the correspondence information generation unit generates the correspondence information by using a character string formed with alphabets.

6. The information processing system according to claim 3, wherein
the first encrypted information generation unit includes a dictionary data storage unit that stores dictionary data as data which indicate correlations among the plural words, and
the word extraction unit extracts a word included in each of the plural pieces of processing target information by using the dictionary data.

7. The information processing system according to claim 3, wherein
each of the plural pieces of processing target information includes attribute information as information representing a different attribute for each piece of the processing target information,
the first encrypted information generation unit includes an ID attachment unit which attaches an ID to each of the plural pieces of processing target information and a communication unit which associates the ID corresponding to the first encrypted information with each of plural pieces of the first encrypted information and transmits the ID and the first encrypted information to the second information terminal,
the second encrypted information generation unit processes plural pieces of the first encrypted information associated with the IDs and generates the second encrypted information, and
the decryption processing unit decrypts the second encrypted information, acquires the processing result information, and attaches the attribute information to the processing result information based on the ID.

8. The information processing system according to claim 2, wherein
the first encrypted information generation unit includes
a word extraction unit which extracts plural words included in each of the plural pieces of processing target information,
a frequency information generation unit which generates, for each of the plural pieces of processing target information, based on the number of appearances of each of the plural words, frequency information as information about an appearance frequency of the word in the processing target information,
a correspondence information generation unit which generates, for each of the plural words which are extracted, correspondence information as information representing a correspondence relationship between the word and a character string corresponding to the word, and
a first encryption processing unit which encrypts the frequency information to form the first encrypted information by converting plural words included in the frequency information based on the correspondence information, and
the decryption processing unit acquires the processing result information by decrypting the second encrypted information based on the correspondence information.

9. The information processing system according to claim 8, wherein
when the processing target information included in the plural pieces of processing target information is changed, the correspondence information generation unit generates new correspondence information by using a character string which is different from a character string used in the correspondence information which is not yet changed.

10. The information processing system according to claim 8, wherein
the correspondence information generation unit generates the correspondence information by using a character string formed with alphabets.

11. The information processing system according to claim 8, wherein
the first encrypted information generation unit includes a dictionary data storage unit that stores dictionary data as data which indicate correlations among the plural words, and
the word extraction unit extracts a word included in each of the plural pieces of processing target information by using the dictionary data.

12. The information processing system according to claim 8, wherein
each of the plural pieces of processing target information includes attribute information as information representing a different attribute for each piece of the processing target information,
the first encrypted information generation unit includes an ID attachment unit which attaches an ID to each of the plural pieces of processing target information and a communication unit which associates the ID corresponding to the first encrypted information with each of plural pieces of the first encrypted information and transmits the ID and the first encrypted information to the second information terminal,
the second encrypted information generation unit processes plural pieces of the first encrypted information associated with the IDs and generates the second encrypted information, and
the decryption processing unit decrypts the second encrypted information, acquires the processing result information, and attaches the attribute information to the processing result information based on the ID.

13. An information processing method in which a second information terminal practices a predetermined process on plural pieces of processing target information transmitted from a first information terminal and the first information terminal acquires processing result information being a result of the predetermined process, the information processing method comprising:
a step of generating first encrypted information as information resulting from encryption of each of the plural pieces of processing target information in the first information terminal;
a step of generating, in the second information terminal, second encrypted information as information which results from practicing the predetermined process on plural pieces of the first encrypted information without decrypting the plural pieces of the first encrypted information; and
a step of decrypting the second encrypted information and of acquiring the processing result information in the first information terminal.
